(19) United States
(12) Patent Application Publication
(10) Pub. No.: US 2011/0149359 A1
(43) Pub. Date: Jun. 23, 2011

(54) ILLUMINATION DEVICE WITH A FILTERING DEVICE

(75) Inventor: Norbert Leister, Dresden (DE)

(73) Assignee: SeeReal Technologies S.A., Munsbach (LU)

(21) Appl. No.: 12/974,222

(22) Filed: Dec. 21, 2010

(30) Foreign Application Priority Data
Dec. 23, 2009 (DE) 10 2009 060 582.7

(51) Int. Cl. G03H 1/08; G02B 26/02; G02F 1/135

(52) U.S. Cl. 359/9; 359/227; 349/24

(57) ABSTRACT

An illumination device having a filtering device is configured such that the filtering device comprises an optically addressable spatial light modulator with a filtering aperture which is generated by addressing. The position of the filtering aperture within the Fourier plane and/or the size of the filtering aperture is controlled by the control unit. The light modulator is addressed such that the position of the filtering aperture in the Fourier plane corresponds with the position of the intermediate image of the activated light source. At the same time the position of the imaged intermediate image corresponds with the detected position in the observer plane, and the size of the filtering aperture is determined by maximal one diffraction order of the light which is diffracted by the electrically addressable spatial light modulator. The field of application of this invention includes holographic projection displays.

### CROSS-REFERENCE TO RELATED APPLICATIONS

This application is based on and claims priority to German Application No. DE 10 2009 060 582.7, filed Dec. 23, 2009, the entire contents of which are hereby incorporated fully herein by reference.

### BACKGROUND OF THE INVENTION

The present invention relates to an illumination device with a light source array for illuminating an electrically addressable spatial light modulator, with imaging means for imaging at least one activated light source of the light source array into the Fourier plane of the electrically addressable spatial light modulator as an intermediate image and for imaging the intermediate image to a detected position in the observer plane, with a filtering device which is disposed in the Fourier plane and with a control unit for controlling the light sources, light modulator and filtering device. The present invention further relates to a holographic projection display which includes the illumination device according to this invention.

The field of application of the invention includes holographic projection displays with an observer window from which a holographic reconstruction of a 3D scene can be watched. The observer window is generated as a Fourier transform of a hologram which is written to a spatial light modulator (SLM); it lies within one periodicity interval of the used transform.

In holographic projection displays with an electrically addressable spatial light modulator (EASLM) as light modulator means, there is the challenge to suppress or to minimise higher diffraction orders of the coherent light as far as possible in order to avoid cross-talking of the holographic reconstruction which is generated for one eye to the other eye. The higher diffraction orders are created when the coherent light is modulated by way of diffraction at the pixel matrix of the EASLM. This impairs the quality of the generated holographic reconstruction.

The higher diffraction orders can be filtered out e.g. by way of filtering in a filtering plane. This filtering can be realised either with the help of a filtering device with a fixed shutter in the optical path, or with the help of a shutter with variable filtering aperture.

A fixed shutter can for example be an aperture mask with apertures. The aperture is dimensioned such that a defined diffraction order of the incident light or at least a part of it is filtered out in the filtering plane and thus transmitted. Light which falls on the aperture mask outside the aperture is blocked from further propagation. The size of the aperture is dimensioned such that it corresponds with the size of the intermediate image of an observer window which is to be generated. The aperture has a fix position so that the filtering always takes place at that position.

In order to track the observer window to the changed position of an observer in front of the display device, it is for example possible to realise a light source tracking, i.e. in that the pattern of activated light sources is changed. A thus designed holographic projection display is described in document DE 10 2005 023 743 filed by the applicant.

However, light source tracking cannot be combined with a static filtering of higher diffraction orders, because the intermediate image of the observer window in the filtering plane will also be displaced or partly filtered out if the position of the light source is changed. Further, correct filtering requires an unchangeable optical path prior to the filtering plane, but this tracking affects this optical path.

Reducing higher diffraction orders of the light is possible in analogy with the known Fourier filtering or 4f filtering, in that the higher diffraction orders are filtered with two imaging means and a filter in the focal plane between the two imaging means. A 4f filtering is disclosed for example in document DE 10 2007 019 277 filed by the applicant. According to that, the filtering is achieved in a direct-view display by a pixelated electronic shutter panel which serves as a filter. The filtering device is based on a lens array where each lens is assigned with a filtering aperture of a filtering aperture array. When tracking the observer window, a filtering is achieved in that the shutter is switched to a transparent mode in steps of one pixel. However, this arrangement cannot be applied to a holographic projection display. The shutter panel would have to have very large pixels, while the aperture had the size of a pixel, and displacing the aperture would only possible in very large steps. Moreover, the pixelated structure of the shutter would again cause new higher diffraction orders to occur.

Still further, a light modulator with pixel matrix is prone to misalignment. The pixels have to be precisely aligned with the light source array in order to realise the defined position of the aperture.

The 4f filtering shall be applied to a projection display with only one mirror as the second imaging means after the filtering plane. The focal lengths of the two imaging means must differ.

Further, an optically addressable spatial light modulator (OASLM) with liquid crystal layer, as described in document Fuh et al., “Spatial filter based on azo-dye-doped liquid crystal films”, Proc. SPIE 6487 64870E-1, can also be used as filter. In this OASLM, the liquid crystal (LC) molecules are given a defined spatial distribution, i.e. a uniform preferential orientation, by light which falls on one side of the OASLM. This is achieved by a variation in the intensity or polarisation of the light that falls on the OASLM as controlled by a control means.

The LC layer in the OASLM is doped with azo-dye molecules. If light falls on such an OASLM, then the major axes of the dye molecules will be oriented at right angles to the direction of polarisation of the light.

If the incident luminous intensity reaches a certain value, then a twisted nematic (TN) structure will be created in the cell. This TN structure will turn the polarisation of the incident light by 90° —given a suitable thickness of the LC layer. This turning will only take place in regions of the OASLM where the incident luminous intensity is high enough. Other regions of the OASLM will transmit the incident light without any change in the direction of polarisation.

The incident light is also referred to as write light. Light of identical wavelength is used both as write and read light.

In the context of this document, the term OASLM shall generally cover all kinds of controllable spatial light modulators, which can be given a certain modulation characteristic in an optical way.

### SUMMARY OF THE INVENTION

It is the object of the present invention to overcome the problems described in the prior art section above which are encountered when using controllable light modulators in illumination devices with filtering devices. In particular, a filtering device shall be provided which enables a variable control of the filtering aperture.

The illumination device shall realise a tracking of observer windows in at least two directions in holographic projection displays and simplify the sequential generation of the observer windows for a right and a left eye of respective observers, at specifiable positions in observer planes with the help of a filtering device.

The solution is based on an illumination device with a light source array for illuminating an electrically addressable spatial light modulator, with imaging means for imaging at least one activated light source of the light source array into the Fourier plane of the electrically addressable spatial light modulator as an intermediate image and for imaging the intermediate image to a detected position in an observer plane, with a filtering device which is disposed in the Fourier plane and with a control unit for controlling the light sources, light modulator and filtering device.

The object is solved according to this invention in that
The filtering device comprises an optically addressable spatial light modulator with a filtering aperture which is generated by corresponding addressing,
The position of the filtering aperture within the Fourier plane and/or its size is controlled by the control unit, where the optically addressable spatial light modulator is addressed such that the position of the filtering aperture in the Fourier plane corresponds with the position of the intermediate image of the activated light source, that at the same time the position of the imaged intermediate image corresponds with the detected position in the observer plane and that the size of the filtering aperture is determined by maximal one diffraction order of the light which is diffracted by the electrically addressable spatial light modulator.

In an embodiment of the invention, the imaging means comprise a first imaging means for imaging the at least one activated light source into the Fourier plane as an intermediate image and a second imaging means for imaging the intermediate image to the detected position in the observer plane to serve as observer window.

The optically addressable spatial light modulator is addressed by a modulation of the light in the electrically addressable spatial light modulator, preferably with a defined intensity distribution which is written to the electrically addressable spatial light modulator in the form of a hologram.

The embodiment of the illumination device for coloured illumination comprises a light source array of red, green and blue light sources, where the size of the filtering aperture is preferably controlled to correspond with one diffraction order of the light which is emitted by an activated blue light source and which is diffracted by the electrically addressable spatial light modulator.

The optically addressable spatial light modulator exhibits a transmittance which will change as the polarisation or intensity of write light varies. The position and size of the filtering aperture can preferably be written to the optically addressable spatial light modulator by the spatial gradient of polarisation or intensity of the incident write light.

It is also possible to use additional light sources to provide the write light. The optically addressable spatial light modulator can also be addressed in that the control unit controls the optically addressable spatial light modulator with additional light of a different wavelength. However, the light which is emitted by at least some of the light sources can be used as both write light and read light, so to keep the light source array as simple as possible.

According to this invention, a new position and/or a new size of a new filtering aperture can be written after deletion of a previously encoded filtering aperture. The deletion is realised by applying a common electrical voltage to the entire area of the optically addressable spatial light modulator for a specified period of time, during which the electrically addressable spatial light modulator does not show any information.

According to a further embodiment of the present invention, a shutter panel is disposed between the intermediate image plane and the second imaging means in the optical path of the illumination device, said shutter panel being switchable to minimum transmittance during the writing operation and/or deleting operation and to maximum transmittance during the reading operation.

Further, the optically addressable spatial light modulator can be switched binary between a maximum and a minimum transmittance, where the maximum transmittance is triggered by write light with an intensity above a certain threshold value, and the minimum transmittance is achieved during the deleting operation. The position and size of the region with maximum transmittance determines the filtering aperture in the optically addressable spatial light modulator. The transmittance values are controlled by the control unit.

A transmittance gradient can be realised across the filtering aperture by setting various transmittance values other than the minimum transmittance at the position and size of the filtering aperture.

Amplitude and/or phase values are written to the electrically addressable spatial light modulator for modulating write light which is emitted by at least one light source such that the Fourier transforms of these amplitude and/or phase values approximate the defined intensity distribution for writing the filtering aperture to the optically addressable spatial light modulator.

According to another embodiment of the illumination device, the optically addressable spatial light modulator comprises a dye-doped liquid crystal layer, whose dye molecules are oriented by the write light such that the liquid crystal molecules will be re-oriented above an intensity threshold of the write light.

Further, the illumination device according to this invention can be realised in an holographic projection display where a reconstructed 3D scene is visible for an observer through an observer window.

The holographic projection display comprises an illumination device according to one of claims 1 to 13, where the illumination device has a filtering plane and an observer plane, where an observer window can be generated in the observer plane by imaging at least one activated light source and a hologram which is encoded on the electrically addressable spatial light modulator of the illumination device, where diffraction orders are filtered in the filtering plane dependent on the position of the intermediate image of the activated light source in the observer plane and where the projection display includes a control unit for controlling at least the light sources, the light modulator and the filtering device.

### BRIEF DESCRIPTION OF THE DRAWINGS

The invention will now described in more detail below with the help of embodiments and in conjunction with the accompanying schematic drawings, where

FIG. 1a, b are general diagrams which illustrate an illumination device according to this invention with a filtering device with controllable filtering aperture in the Fourier plane of a controllable light modulator,

FIG. 2a, b are graphic representations of the intensity distribution before and after filtering higher diffraction orders,

FIG. 3 is a general diagram which illustrates an embodiment of writing a filtering aperture to an SLM with coherent light (writing operation), and

FIG. 4 is a general diagram which illustrates a reading operation of a filtering aperture in an SLM with coherent light.

### DETAILED DESCRIPTION

The present invention is based on the following principle: In addition to illuminating an SLM, the illumination device according to this invention shall simultaneously filter higher diffraction orders of used coherent light in the optical path. Only one defined diffraction order shall be transmitted to a position in the image plane. This position in the image plane is variable in at least two dimensions.

At least one activated light source of a light source array illuminates an electrically addressable spatial light modulator (EASLM) and is imaged as an intermediate image into an intermediate image plane by a first imaging means.

Diffraction at the pixel structure of the EASLM causes intermediate images of the activated light source(s) with periodic continuation of the higher diffraction orders of the light to appear in this image plane. The distance between two instances of periodic continuation represents the size of a diffraction order. The higher diffraction orders can be filtered out with the help of a filtering device in that image plane. The filtering aperture is imaged into a second image plane by a second imaging means such that maximal one diffraction order occurs there.

Filtering out here means that certain diffraction orders of the light shall not be transmitted through the filtering aperture. The filtering device withholds the light of those diffraction orders in the filtering plane and lets pass only one defined diffraction order.

According to this invention, an optically addressable spatial light modulator (OASLM) serves as the filtering device in the filtering plane, where it is possible to displace the positions of filtering apertures on said OASLM following a change in the position of light source images.

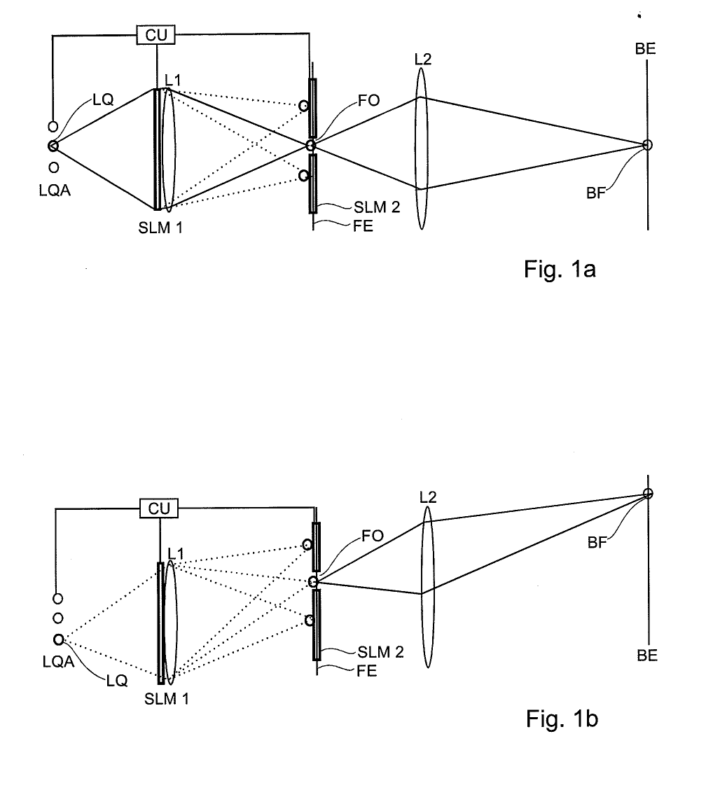

FIGS. 1a and 1b show schematically the general layout of an illumination device according to this invention with a filtering device in the Fourier plane of a controllable light modulator according to a first embodiment of this invention as a top view.

Referring to FIG. 1a, the filtering device is disposed in the Fourier plane FE of a pixelated, electrically addressable spatial light modulator SLM 1. The light modulator SLM 1 is illuminated by a light source array LQA, of which only one row with three light sources is shown in the drawing, where one light source LQ is activated. The light modulator SLM 1 is immediately followed in the optical path by a first imaging means L1 in the form of a lens. The Fourier plane FE of the light modulator SLM 1 also serves as the first image plane and as the filtering plane of the filtering device. The latter is an optically addressable spatial light modulator SLM 2. Both the position and size of the filtering aperture FO of the light modulator SLM 2 can be varied in the filtering plane.

A control unit CU controls at least the selection and switching of the light sources LQ, the encoding of the light modulator SLM 1 and the switching of the light modulator SLM 2 to the transparent mode. The light modulator SLM 2 is followed by a second imaging means L2 to image the intermediate image of the activated light source(s) LQ into a second image plane.

The imaging of the periodic continuations of the activated light source LQ into the Fourier plane FE is indicated by dotted lines in the drawing. Only one defined diffraction order will pass the filtering aperture FO in the light modulator SLM 2. An intermediate image of the activated light source LQ appears in the Fourier plane FE.

Referring to FIG. 1b, the arrangement of the individual components is the same as in FIG. 1a, but a different light source LQ of the light source array LQA is activated. The intermediate image of the light source LQ, and with it the continuation of the intermediate image in the form of higher diffraction orders, have moved to a different position in the intermediate image plane or Fourier plane FE, compared with the situation shown in FIG. 1a. Consequently, the position of the filtering aperture FO in the light modulator SLM 2 has also changed. This means that the filtering aperture FO is generated at a new position in the light modulator SLM 2 that corresponds to the position of the intermediate image of the other light source LQ, where again only maximal one diffraction order is transmitted while all other diffraction orders are blocked by this filtering aperture FO. The size of the filtering aperture FO is determined by the diffraction order to be transmitted.

The filtering aperture FO can for example be of rectangular shape. Its horizontal size is then no larger than one horizontal diffraction order of the light modulator SLM 1, and its vertical size is no larger than one vertical diffraction order of the light modulator SLM 1.

According to one embodiment of the present invention, the filtering aperture FO is encoded on the light modulator SLM 2 by way of addressing it with coherent write light. The control unit CU controls the light modulator SLM 2 such that a sub-region of it becomes transparent while the remaining area exhibits a state of minimum transmittance to the light. The set transmittance of the transparent sub-region of the light modulator SLM 2 is greater than the minimum transmittance of the remaining area. The filtering process is then carried out in a reading operation with coherent light with the help of the filtering aperture which has been created as described above.

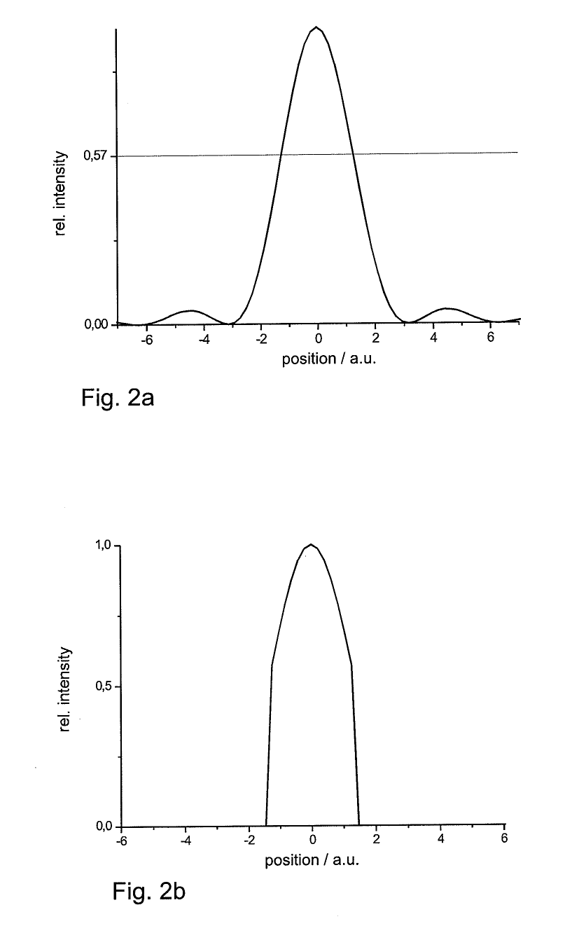

FIG. 2a illustrates a relative spatial intensity distribution of write light before filtering by the filtering aperture in the OASLM, which is disposed in the optical path of the illumination device. In this example, the intensity distribution roughly corresponds with a [sin (x)/x]² curve, where x represents the position of the filtering aperture.

The filtering device can here for example be an LC-type OASLM as the light modulator SLM 2. It exhibits a binary characteristic. Above a certain intensity threshold of the write light which falls on one side of the LC-type OASLM, the LC molecules will be re-oriented by switching or displacing the transparency of the surface of the LC-type OASLM. The realisable resolution of the OASLM depends on how finely the intensity or polarisation of the write light can be spatially varied.

Depending on the thus achievable orientation of the LC molecules, an OASLM can then modulate the amplitude and/or phase of incident light (read light) itself. The wavelength of the write light typically differs from that of the read light. The orientation of the LC molecules is then only affected by light of a certain wavelength range. The LC-type OASLM can then be used to modulate light of a different wavelength range.

This embodiment allows for example to filter diffraction orders with high intensity above the threshold value and diffraction orders of low intensity below the threshold value.

In the chart, the threshold value is about 0.57 times the maximum intensity of the write light. This means that a filtering aperture is written to the LC-type OASLM whose size is defined by the section of the straight line parallel to the x axis at 0.57 that lies between its intersecting points with the write light intensity curve.

Referring to FIG. 2a, the spatial intensity distribution of the write light which must be set to encode the LC-type OASLM usually differs from the intensity distribution of the light source image of a single activated light source.

In an illumination device which uses multiple light sources or which uses different light sources for write light and read light, it is for example also possible that multiple adjacent light sources of the light source array are turned on to provide write light. The intensity profile to be achieved in the filtering plane then results from a superposition of the light source images. In such case, it is also possible to use incoherent light sources for the writing operation.

FIG. 2b shows the intensity distribution of the light as filtered by the filtering aperture according to another embodiment which uses identical write and read light, i.e. where the same light sources LQ are activated to provide both write light and read light. The same light that is used to write the filtering aperture is also filtered by that filtering aperture. Light with an intensity distribution below the threshold value is suppressed.

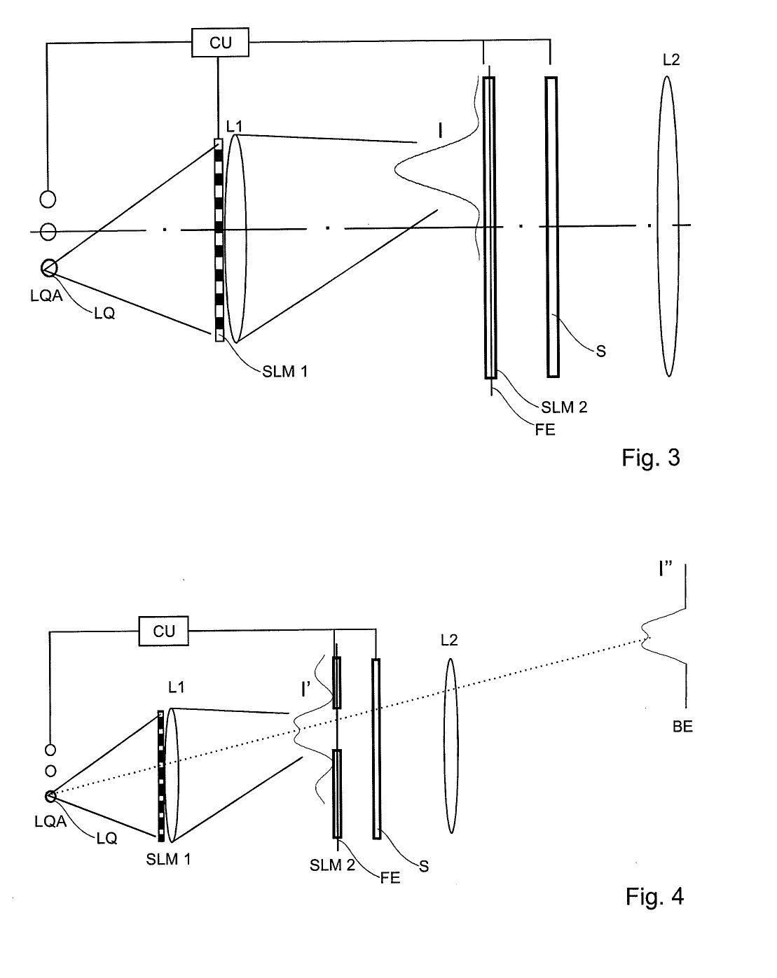

FIG. 3 shows an illumination device according to this invention and illustrates schematically a writing operation with coherent light to encode a filtering aperture on a light modulator.

According to a further embodiment of the illumination device, the light modulator SLM 1 is used in conjunction with a light source array LQA whose light sources LQ emit coherent write light. FIG. 3 also illustrates components which have been shown in and described in conjunction with FIGS. 1a and 1b. In addition, a shutter panel S is disposed between the light modulator SLM 2 and the imaging means L2 in the form of a lens. The control unit CU here controls the selection and switching of the for example one light source LQ of the light source array LQA, the encoding of the light modulator SLM 1 and the switching of sub-regions of the light modulator SLM 2 to the transparent mode.

The first imaging means L1 images an activated light source LQ into the first image plane, i.e. onto the light modulator SLM 2, with an intensity distribution I. This intensity distribution is drawn in front of the light-modulator SLM 2 in the optical path. Since this image plane coincides with the filtering plane and the Fourier plane FE of the light modulator SLM 1, amplitude and/or phase values can be written to the light modulator SLM 1 in the form of a hologram for the writing operation. The intensity distribution I of the write light is then characterised by the Fourier transforms of those values, said intensity distribution being proportional to the squared amplitude values of the Fourier transforms and generating the filtering aperture FO in the light modulator SLM 2.

According to another embodiment of the present invention, writing and reading operation are carried out independently of each other in the illumination device. Write and read light are then not identical, and the wavelength of the write light differs from that of the read light. The writing operation can for example involve UV light, which means that the light source array comprises additional light sources which will only be used for the writing operation.

If UV light is used for writing, for example, then this light will be blocked by the shutter panel S in the optical path, as shown in FIG. 3. For this, the shutter panel S can be switched by the control means CU to minimum transmittance during the writing operation and/or deleting operation, and to maximum transmittance during the reading operation. The UV light does not reach the second image plane. The reading operation then uses visible light. Both coherent and incoherent write light sources may be used.

According to another embodiment, the writing operation to the light modulator SLM 2 can be affected by a voltage that is applied by the control unit CU such that the writing operation with write light will only be enabled if the voltage is applied or, alternatively, only if no voltage is applied. It is then for example possible to use the same light source to provide both write light and read light. For this, a first hologram is written to the light modulator SLM 1 to generate a write light distribution, and a voltage is applied to the light modulator SLM 2 to write an aperture function. Subsequently, a reading operation can be performed in that another hologram is written to the light modulator SLM 1 which generates an intensity distribution which differs from the intensity distribution of the read light. The voltage which is applied to the light modulator SLM 2 will be turned off and the intensity distribution of the read light is filtered such that no disturbing variation in the aperture occurs in the filtering device.

Generally, a hologram which is written to the light modulator SLM 1 can serve multiple light sources LQ of the light source array LQA.

If the position of the light source which is to be activated changes in the illumination device, which is for example a component of a holographic display with an observer window, so that the position of the intermediate image on the light modulator SLM 2 also changes, there will always automatically be a region on the light modulator SLM 2 where the write light can write a corresponding aperture function with a given intensity distribution. The position of the intermediate image can change as a result of a changing position of the observer or by time division multiplexing of sub-observer windows. The luminous intensity distribution is then above a threshold value in the relevant region. This is why a synchronisation of the light modulator SLM 2 with the position of the light sources is not necessary and, moreover, the light modulator SLM 2 does not have to be aligned with such a high precision in the lateral direction either.

Generally, a single OASLM or a single shutter panel do not transmit 100% of the incident light in the transparent mode, but still exhibit a low transmittance. A combination of the OASLM and the shutter panel allows a maximum transmittance and a minimum transmittance to be realised.

The filtering aperture in the OASLM is thus realised in that maximum transmittance is set within the filtering aperture and minimum transmittance is set outside the filtering aperture.

FIG. 4 illustrates the reading operation in the device described above in conjunction with FIG. 3. The light modulator SLM 1 is encoded with other amplitude and phase values as in FIG. 3; they generate a different intensity distribution I′ for a filtering aperture FO.

If this illumination device is a part of a holographic projection display with an observer window, then a hologram of the 3D scene is written to the light modulator SLM 1 for the reading operation. The generated intensity distribution I′ in the intermediate image plane then corresponds with the intensity distribution of the intermediate image with which the observer window BF is generated.

The filtering aperture FO in the light modulator SLM 2 is generated as described in conjunction with FIG. 3. In this case, the shutter panel S is switched to the transparent mode, so that the filtering aperture FO can be imaged to the second image plane with the intensity distribution I″ without any obstructions.

Now, it will be explained how the control unit CU writes and deletes a filtering aperture in the light modulator SLM 2.

Referring to FIGS. 3 and 4, the light modulator SLM 2 is for example designed such that above a certain intensity threshold of the write light the LC molecules will be oriented such to realise a defined condition, while the existing condition is not changed below that threshold value. The sub-region on the light modulator SLM 2 where the intensity of the write light is above that threshold will be controlled such to exhibit maximum transmittance. A sub-region of the light modulator SLM 2 below that intensity threshold will remain black, i.e. in the condition of minimum transmittance.

In this case, write light whose intensity changes continuously with the location can also encode a filtering aperture FO with a sharp boundaries on the light modulator SLM 2.

In addition, the light modulator SLM 2 has a deleting function to set the entire surface of the panel to minimum transmittance, so that the encoded filtering aperture FO can be deleted again. The position and/or size of a filtering aperture FO can be varied by deleting one filtering aperture FO and subsequently writing a new one.

The deleting function can be realised by a common voltage which is applied in regular intervals to switch the entire surface of the light modulator SLM 2 to minimum transmittance. Alternatively, the light modulator SLM 2 is designed such that it will automatically return to the condition of minimum transmittance if the intensity of the write light falls below the threshold for a certain period of time.

According to another embodiment, coloured light is generated in the illumination device to be able to represent information in colour. A light source array comprises light sources which emit light of different wavelengths, e.g. red, green and blue light. Blue light is for example used both for writing the filtering aperture and for reading. Light of the other two wavelengths is only used for reading.

An illumination device of this type can be used in a holographic display device to generate coloured holographic reconstructions. The diffraction orders of red, green and blue light differ in size. It makes sense to choose the size of an observer window such that it corresponds with the size of a full diffraction order of blue light, but only a part of the size of a full diffraction order of red and green light. In absolute terms, this will then result in the same size of the observer window for all three colours.

If blue light is used as write light, this write light also defines the size of the filtering aperture. Red and green light will then be filtered through a filtering aperture with the same size as for blue light.

The form of the filtering aperture which is written to the OASLM can be designed such that a filtering can be performed optionally in one or in two dimensions. In particular, a slot-shaped aperture realises a filtering of diffraction orders in one dimension, while a round or rectangular aperture realises a filtering of diffraction orders in two dimensions.

For example, in an EASLM with pixels which are arranged in a rectangular but not square grid, the size of a diffraction order in the horizontal direction differs from that in the vertical direction. If a filtering in two dimensions is desired, a rectangular filtering aperture in the OASLM is preferred.

According to a further embodiment, the OASLM can exhibit a transmittance that is variable in steps or continuously depending on the intensity of the incident write light instead of showing a binary behaviour. This means that at least one further transmittance value can be set which is higher than the minimum transmittance but lower than the maximum transmittance. This serves in particular to write a filtering aperture which does not exhibit sharp boundaries but a step-like or continuously variable brightness gradient. A filtering aperture with this brightness gradient will still transmit parts of the light at the margins of the aperture, while other parts are already filtered out.

In the illumination device, the imaging means, the EASLM and/or the OASLM can either be of a transmissive or reflective type. A curved mirror serves as an example of a reflective imaging means.

A filtering aperture is written to a reflective OASLM such that light is reflected in the region of the filtering aperture. Outside the filtering aperture, the incident light is either absorbed or transmitted.

Now, the functional principle of the filtering with the help of an OASLM will be described in more detail with the example of two embodiments.

According to a first embodiment, the illumination device is a part of a holographic projection display with observer window. The observer window is imaged into a second image plane, which is the observer plane, more precisely to a position where a position detection system has detected observer eyes.

The coherent light which is modulated by the EASLM of the illumination device such to generate a holographic reconstruction is used both as write light and read light.

According to the detected observer position, the control unit selects and turns on at least one light source of the light source array. Alternatively, an already activated light source is displaced such that the image of this at least one activated light source in the second image plane, which is the observer plane, coincides with the detected eye position of the observer.

Further, the position of the intermediate image in the filtering plane of the activated light source(s) is detected. A control unit writes an aperture function to the OASLM of the filtering device such that a sub-region of the OASLM is switched to a transparent mode so to serve as filtering aperture. This sub-region has such a size that of the at least one activated light source maximal one diffraction order is transmitted while the other diffraction orders are filtered out.

For this procedure, a hologram is written to the EASLM with light such that the observer window is generated in the second image plane, and an intermediate image of the observer window is generated in the first image plane, which simultaneously serves as the intermediate image plane of the activated light source. The observer window can have a size that is no larger than the size of one diffraction order both in the horizontal and vertical direction.

The higher diffraction orders are filtered in the Fourier plane of the EASLM. The higher diffraction orders exhibit a periodic continuation of the observer window which is to be generated. Due to the pixelated structure of the EASLM, the intensity decreases as the number of diffraction order increases. This is an optical analogy to a mathematic multiplication of the Fourier transform of the encoded hologram with the diffraction pattern of the single pixel of the EASLM. For a rectangular pixel with constant transmittance across its area, the drop in intensity can for example be described by (sin (x)/x)², which is represented by a curve similar to that shown in FIG. 2a.

In a holographic projection display, however, an intensity is required that is constant on a spatial average across small sections within the observer window, so that an observer whose eye pupil moves within this observer window perceives the 3D scene at constant brightness. Light in the observer plane but outside the observer window whose intensity forms a disturbance to the other eye or to other observers is filtered out by a filtering device which is disposed between the EASLM and observer.

The filtering aperture is realised by the OASLM and can be adapted to a changing position of the observer in two dimensions in front of the display, e.g. in the X and Z direction, and thus to the changed position of the observer window.

If a hologram of a 3D scene is encoded on the EASLM where the amplitude and phase values are distributed almost randomly, the intensity distribution in the filtering plane resembles the diffraction pattern of a single pixel.

The intensity threshold of the write light which triggers a reaction in the OASLM must then be set by the control unit such that it lies on the slopes of the main peak of the (sin (x)/x)² function, as is shown for example in FIG. 2a. That drawing illustrates a (sin (x)/x)² function with main peak and first side peaks to the left and right. The threshold value of 0.57, which is given there, intersects the steep slopes of the main peak.

The write light causes that sub-region of the OASLM (which is disposed in the Fourier plane) in which the luminous intensity exceeds the threshold value to be switched to the transparent mode. The central area of the diffraction pattern will be transmitted by the OASLM when the OASLM has become transparent at that position. The adjacent diffraction orders, which have a lower intensity, will not be transmitted, because their intensity is below the threshold for switching the OASLM to the transparent mode. This is shown in FIG. 2b. This chart illustrates the part of the light of FIG. 2a which passes the filtering device. The difference between the curves in FIG. 2a and FIG. 2b is the portion of the light that is filtered out.

The threshold for the OASLM must be defined such that the intensity exceeds this threshold value within the observer window to be generated in the second image plane while it falls below that threshold value outside the observer window. This can be achieved by varying the total intensity of the light sources. FIG. 2a only illustrates a relative intensity curve. The threshold can be translated up or down on this curve e.g. by increasing the intensity of the light source.

A displacement of the diffraction pattern in the filtering plane e.g. by switching over to another light source automatically causes a shift of the luminous intensity in the filtering plane, so that the filtering aperture also moves to a different position on the OASLM.

In this embodiment, a change in the content of the 3D scene also means that the hologram which is written to the EASLM is different, which induces a different total intensity in the observer window or in the filtering plane, thus also varying the intensity at the edges of the observer window.

Since the intensity threshold required to switch the OASLM to the transparent mode is unchangeable, this embodiment of the filtering device does not always permit all higher diffraction orders to be filtered out precisely.

However, this can be circumvented by a temporal intensity modulation of the light sources, which will be described below.

In a first time interval T1, which serves to write the filtering aperture, the intensity of the activated light sources is modulated such that a defined intensity distribution is achieved in the filtering plane. In a second time interval T2, the intensity is changed by the control unit such that an observer perceives the reconstruction of the 3D scene at the correct brightness.

Instead of the light source, the shutter panel S according to FIGS. 3 and 4 can also be used to control the brightness at which an observer shall perceive the 3D scene, in that the shutter is switched to maximum transmittance during a first time interval, while it is switched to minimum transmittance for a second time interval.

According to a second embodiment of a holographic projection display with an observer window, the same activated light sources but different holograms encoded on the EASLM are used for the writing operation on the one hand and for the reading operation on the other. In particular, a fix hologram is always used for the writing operation, said hologram causing a defined intensity distribution to be generated in the filtering plane. However, the position of this intensity distribution is variable depending on which light source is activated. The holograms for the reading operation can then vary depending on the content of the 3D scene. The hologram for the writing operation and the hologram for the reading operation are encoded on the EASLM one after another, while the same light source remains activated. This corresponds roughly with the timing of the arrangements which are illustrated in FIGS. 3 and 4.

The filtering device described above is not only able to track the observer window, but also to simplify a sequential presentation of information in the observer window for the left and right eye of an observer.

Two observer windows, namely one for a left eye and one for a right eye of an observer, or one each for a specific eye of two observers (i.e. altogether two left eyes or two right eyes), can for example be generated one after another, in that different light sources are activated and different filtering apertures are written to the filtering device for each observer window.

Instead of two observer windows, one each for a left and for a right eye, it is also possible that a large observer window is composed of multiple smaller, mutually incoherent sub-observer windows are generated in this filtering process.

These sub-observer windows are generated one after another for a once detected eye position in that different light sources are activated and that different holograms are written to the EASLM so to generate different filtering apertures (aperture functions) in the OASLM.

Mutual cross-talking between the individual sub-observer windows can be prevented by varying the position of the filtering aperture in the filtering plane according to the position of the sub-observer windows, where the sub-observer windows are imaged one after another into the observer plane as filtering apertures while disturbing diffraction orders are filtered out.

There is a firm mathematical relation between the size of an EASLM pixel and the size of the coherent observer window. If a sufficiently fast EASLM with a given pixel pitch is used, the total observer window can generally be enlarged in that multiple, mutually incoherent sub-observer windows are generated one after another at a fast pace. An observer then sees a reconstruction of the 3D scene in each of those sub-observer windows.

According to a third embodiment, different light sources serve for different purposes in the illumination device. An array of light sources which emit coherent light is required to illuminate the EASLM and to reconstruct the 3D scene. Additional light sources are required which only emit write light to address the OASLM.

These additional light sources are preferably arranged in a matrix such that they are situated between the light sources which provide the read light, so that the intermediate image of a write light source in the filtering plane roughly corresponds with the position of the intermediate image of the adjacent read light source.

These separate write light sources can be combined with the encoding of a hologram for the writing operation on the EASLM so to generate a luminous intensity that serves to generate a filtering aperture in the filtering plane. If a lateral offset between write and read light source in the light source array is to be compensated, a hologram for the writing operation is encoded on the EASLM such that the filtering aperture is situated concentrically with the intermediate image of the read light source.

The following steps are carried out repeatedly in this process: First, the defined sub-region of the OASLM is switched to the transparent mode at the desired position with the help of the write light source. Then, the light which is emitted by the read light source and modulated by the light modulator so to generate the holographic reconstruction is filtered by the OASLM in the Fourier plane. After that, the encoded filtering aperture on the OASLM will be deleted.

Writing and reading operation are similar to what was said in conjunction with FIGS. 3 and 4. However, the shutter panel in FIG. 3 can in this case be replaced by a passive filter, e.g. a wavelength-sensitive filter which blocks the write light and which transmits the read light.

For tracking the observer window, both light source arrays, i.e. the write light source array and the read light source array, can for example be controlled by the control unit in the same way. Moreover, at least one light source array can be generated virtually.

In the holographic projection display for colour representations, an observer window is typically created by superposition of observer windows of different wavelengths, e.g. of red, green and blue light.

The size of the diffraction orders differs among the individual wavelengths. The observer window is preferably chosen in accordance with the size of a diffraction order of the smallest wavelength used.

For filtering, the filtering aperture is chosen to be of identical size for all wavelengths, so that a uniformly sized observer window is generated in the second image plane. For this, the light source array comprises light sources of multiple wavelengths. The light source array preferably comprises adjacently arranged pairs of light sources of the individual wavelengths. A pairs preferably includes one light source each of the used wavelengths for red, green and blue light.

Referring to the embodiments, the writing operation can be carried out either independent with an additional wavelength that is not used for the colour representation, as described in the third embodiment,

or one wavelength can be used for both writing and reading while the other wavelengths are exclusively used for reading, as described in the first and second embodiments.

According to the second embodiment, a writing operation to generate a filtering aperture can be carried out first with blue light, and then the diffraction orders of the blue, green and red light can be filtered one after another by the generated filtering aperture. A deletion will only be initiated when the filtering process with the same filtering aperture has been completed for all three wavelengths.

1. Illumination device comprising a light source array for illuminating an electrically addressable spatial light modulator, imaging means for imaging at least one activated light source of the light source array into the Fourier plane of the electrically addressable spatial light modulator as an intermediate image and for imaging the intermediate image to a detected position in an observer plane, a filtering device which is disposed in the Fourier plane, and a control unit for controlling at least the light sources, light modulator and filtering device, wherein
The filtering device comprises an optically addressable spatial light modulator with a filtering aperture which is generated by corresponding addressing,
The position of the filtering aperture within the Fourier plane and/or its size is controlled by the control unit, where the light modulator is addressed such that the position of the filtering aperture in the Fourier plane corresponds with the position of the intermediate image of the activated light source, that at the same time the position of the imaged intermediate image corresponds with the detected position in the observer plane and that the size of the filtering aperture is determined by maximal one diffraction order of the light which is diffracted by the electrically addressable spatial light modulator.

2. Illumination device according to claim 1, comprising a first imaging means for imaging the at least one activated light source into the Fourier plane as the intermediate image and a second imaging means for imaging the intermediate image to the detected position in the observer plane to serve as observer window.

3. Illumination device according to claim 1, wherein the optically addressable spatial light modulator is addressed by a modulation of the light in the electrically addressable spatial light modulator with a defined intensity distribution which is written to the electrically addressable spatial light modulator in the form of a hologram.

4. Illumination device according to claim 2, wherein the light source array comprises red, green and blue light sources and where the size of the filtering aperture is controlled to correspond with one diffraction order of the light which is emitted by an activated blue light source and which is diffracted by the electrically addressable spatial light modulator.

5. Illumination device according to claim 1, wherein the position and size of the filtering aperture are encoded in the form of the spatial gradient of polarisation of incident write light or in the form of the spatial intensity gradient of incident write light such to modify the transmittance in the optically addressable spatial light modulator.

6. Illumination device according to claim 5, wherein additional light sources are used to provide write light.

7. Illumination device according to claim 5, wherein the light of at least a part of the light sources is controlled to serve both as write light and as read light.

8. Illumination device according to claim 5, wherein a new position and/or a new size of a new filtering aperture is/are written after deletion of a previously encoded filtering aperture.

9. Illumination device according to claim 8, wherein the deletion is realised by applying a common electrical voltage to the entire area of the optically addressable spatial light modulator for a specified period of time, during which the electrically addressable spatial light modulator does not show any information.

10. Illumination device according to claim 2, wherein a shutter panel is disposed between the intermediate image plane and the second imaging means in the optical path of the illumination device, said shutter panel being switchable to minimum transmittance during the writing operation and/or deleting operation and to maximum transmittance during the reading operation.

11. Illumination device according to claim 5, wherein the optically addressable spatial light modulator can be switched binary between a maximum and a minimum transmittance, where the maximum transmittance is triggered by write light with an intensity above a certain threshold value, and the minimum transmittance is achieved during the deleting operation, and where the position and size of the region with maximum transmittance defines the filtering aperture.

12. Illumination device according to claim 5, wherein amplitude and/or phase values are written to the electrically addressable spatial light modulator for modulating write light which is emitted by at least one light source such that the Fourier transforms of these amplitude and/or phase values approximate the defined intensity distribution for writing the filtering aperture to the optically addressable spatial light modulator.

13. Illumination device according to claim 11, wherein the optically addressable spatial light modulator comprises a dye-doped liquid crystal layer, whose dye molecules are oriented by the write light such that the liquid crystal molecules are re-oriented above an intensity threshold of the write light.

14. Illumination device according to claim 2, wherein the filtering aperture of the optically addressable spatial light modulator exhibits a step-like or continuously variable brightness gradient.

15. Holographic projection display with an illumination device according to claim 1 comprising a filtering plane and an observer plane, where an observer window can be generated in the observer plane by imaging at least one activated light source and a hologram which is encoded on the electrically addressable spatial light modulator of the illumination device, where diffraction orders are filtered in the filtering plane dependent on the position of the intermediate image of the activated light source in the observer plane and where the projection display includes a control unit for controlling at least the light sources, the light modulator and the filtering device.

16. Holographic projection display according to claim 15, wherein the observer window is composed of sequentially generated sub-observer windows which lie side by side in the observer plane and where the filtering of diffraction orders is carried out sequentially for the individual sub-observer windows.
